(19) United States
(12) Patent Application Publication
(10) Pub. No.: US 2026/0259297 A1
(43) Pub. Date: Sep. 3, 2026

(54) DEVICE AND METHOD FOR CARRYING OUT RADAR COMMUNICATION USING VIRTUAL ARRAY IN WIRELESS COMMUNICATION SYSTEM

(71) Applicant: LG Electronics Inc., Seoul (KR)

(72) Inventors: Seungwoo RYU, Seoul (KR); Jihwan JANG, Seoul (KR); Jaeky OH, Seoul (KR); Jaehoon CHUNG, Seoul (KR); Dong Hwan KIM, Seoul (KR)

(21) Appl. No.: 19/163,674

(22) PCT Filed: Mar. 9, 2023
(86) PCT No.: PCT/KR2023/003259

§ 371 Date: Sep. 9, 2025

(51) Int. Cl. G01S 7/00; G01S 13/46; H04B 7/0456

(52) U.S. Cl. CPC G01S 7/006; G01S 13/46; H04B 7/0456

(57) ABSTRACT

The present disclosure is for carrying out radar communication using frequency hopping in a wireless communication system. An operation method of a communication device may comprise the steps of: generating at least one code word by encoding information bits; generating modulation symbols on the basis of the at least one code word; transmitting signals including the modulation symbols; and if the signals are reflected from an object and received, carrying out a radar operation using the reflected signals. The radar operation may be carried out on the basis of a virtual array which is formed using signals which, during a plurality of time intervals, are transmitted through, among a plurality of subarrays included in an antenna array, at least one subarray operating in at least one polarization state, and are received through at least one other subarray operating in a plurality of polarization states.

### TECHNICAL FIELD

The following description relates to a wireless communication system, and more particularly, to a device and a method for performing radar-communication by using a virtual array in a wireless communication system.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

According to the present disclosure, a scheme may be considered in which a device and a method are provided to effectively perform data communication and a radar operation in a wireless communication system.

According to the present disclosure, a scheme may be considered in which a device and a method are provided to perform a radar operation by using a signal for data communication in a wireless communication system.

According to the present disclosure, a scheme may be considered in which a device and a method are provided to perform a radar operation without loss of channel capacity for data communication in a wireless communication system.

According to the present disclosure, a scheme may be considered in which a device and a method are provided to perform a radar operation by using a virtual array of a signal in a wireless communication system.

According to the present disclosure, a scheme may be considered in which a device and a method are provided to use a system architecture and an antenna array for wireless communication and radar sensing in a wireless communication system.

According to the present disclosure, a scheme may be considered in which a device and a method are provided to utilize the same system hardware and antenna array for wireless communication and a radar operation in a wireless communication system.

According to the present disclosure, a scheme may be considered in which a device and a method are provided to perform high-resolution radar sensing by using limited hardware in a wireless communication system.

According to the present disclosure, a scheme may be considered in which a device and a method are provided to address an ambiguity due to received signal distortion during a radar operation using a virtual array in a wireless communication system.

The technical objects to be achieved by the present disclosure are not limited to the matters mentioned above, and other technical problems not mentioned may be considered by those skilled in the art to which the technical configuration of the present disclosure is applied, from embodiments of the present disclosure to be described below.

### Technical Solution

According to an embodiment of the present disclosure, a method performed by a communication device in a wireless communication system, the method may include: generating, by encoding information bits, at least one codeword; generating, based on the at least one codeword, modulation symbols, transmitting signals including the modulation symbols; and when the signals are reflected by an object and received, performing a radar operation by using the reflected signals. Here, the radar operation may be performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

According to an embodiment of the present disclosure, a communication device, may include: a transceiver connected to the at least one processor and including a plurality of transmitters and a plurality of receivers, wherein the at least one processor may control the transceiver to: generating, by encoding information bits, at least one codeword; generating, based on the at least one codeword, modulation symbols; transmitting signals including the modulation symbols; and when the signals are reflected by an object and received, performing a radar operation by using the reflected signals. Here, the radar operation may be performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

According to an embodiment of the present disclosure, a communication device, may include: at least one processor; at least one computer memory connected to the at least one processor and storing instructions that, based on being executed by the at least one processor, cause the first device to perform operations, wherein the operations may include: generating, by encoding information bits, at least one codeword; generating, based on the at least one codeword, modulation symbols; transmitting signals including the modulation symbols; and when the signals are reflected by an object and received, performing a radar operation by using the reflected signals. Here, the radar operation may be performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

According to an embodiment of the present disclosure, a non-transitory computer-readable medium storing at least one instruction, may include the at least one instruction being executable by a processor, wherein the at least one instruction is configured to perform operations may include: generating, by encoding information bits, at least one codeword; generating, based on the at least one codeword, modulation symbols; transmitting signals including the modulation symbols; and when the signals are reflected by an object and received, performing a radar operation by using the reflected signals. Here, the radar operation may be performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

The above-described aspects of the present disclosure are only some of the preferred embodiments of the present disclosure, and various embodiments reflecting the technical features of the present disclosure may be derived and understood by those skilled in the art based on the following detailed description of the present disclosure.

### Advantageous Effects

According to embodiments based on the present disclosure, effects as follows may be obtained.

According to the present disclosure, a radar operation may be effectively performed by using a signal for data communication.

Effects obtainable in embodiments of the present disclosure are not limited to the effects mentioned above, and other effects not mentioned may be clearly derived and understood by those skilled in the art to which the technical configuration of the present disclosure is applied from the following description of embodiments of the present disclosure. For example, even unintended effects resulting from implementing the configuration described in the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows a concept of a radar-communication operation, based on an embodiment of the present disclosure.

FIG. 12 shows a concept of a multiple input multiple output (MIMO) radar, based on an embodiment of the present disclosure.

FIG. 13 shows a functional structure of a device for forming a virtual array, based on an embodiment of the present disclosure.

FIG. 14 shows an example of a virtual array formed by using antennas shared in a time division duplex (TDD) scheme, based on an embodiment of the present disclosure.

FIG. 15 shows another example of a virtual receive array formed by using antennas shared in a TDD scheme, based on an embodiment of the present disclosure.

FIG. 16 shows an example of a procedure of performing communication and a radar operation, based on an embodiment of the present disclosure.

FIG. 17 shows an example of a procedure of forming a virtual array, based on an embodiment of the present disclosure.

FIG. 18 shows an example of a procedure of configuring antenna subarrays for a radar operation, based on an embodiment of the present disclosure.

FIG. 19 shows an example of a procedure of configuring antenna subarrays for a radar operation by using a plurality of polarizations during four time intervals, based on an embodiment of the present disclosure.

FIG. 20 shows an example of antenna-subarray control for a radar operation and a result of a virtual array, based on an embodiment of the present disclosure.

FIG. 21 shows another example of antenna-subarray control for a radar operation and a result of a virtual array, based on an embodiment of the present disclosure.

FIG. 22 shows an example of a circuit control state that performs a transmission operation in a dual-polarized mode, based on an embodiment of the present disclosure.

FIG. 23 shows an example of a circuit control state that performs a transmission operation in a circular-polarized mode, based on an embodiment of the present disclosure.

FIG. 24 shows an example of a circuit control state that performs a reception operation in a dual-polarized mode, based on an embodiment of the present disclosure.

FIG. 25 shows an example of a circuit control state that performs a reception operation in a circular-polarized mode, based on an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”. “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

For example, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

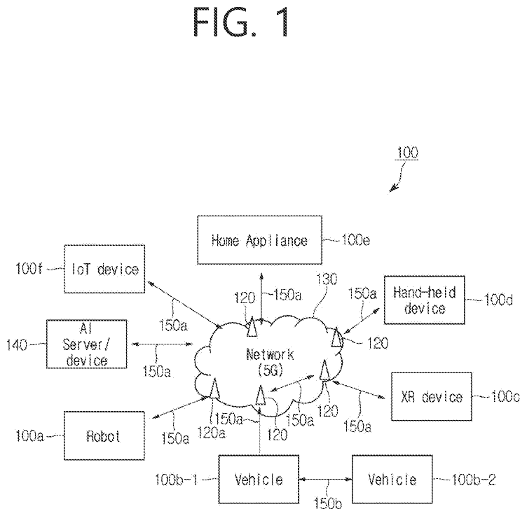

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network or a 5G (e.g., NR) network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

Wireless communications/connections 150 a, 150 b and 150 c may be established between the wireless devices 100 a to 100 f/the base station 120 and the base station 120/the base station 120. Here, wireless communication/connection may be established through various radio access technologies (e.g., 5G NR) such as uplink/downlink communication 150 a, sidelink communication 150 b (or D2D communication) or communication 150 c between base stations (e.g., relay, integrated access backhaul (IAB). The wireless device and the base station/wireless device or the base station and the base station may transmit/receive radio signals to/from each other through wireless communication/connection 150 a, 150 b and 150 c. For example, wireless communication/connection 150 a, 150 b and 150 c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

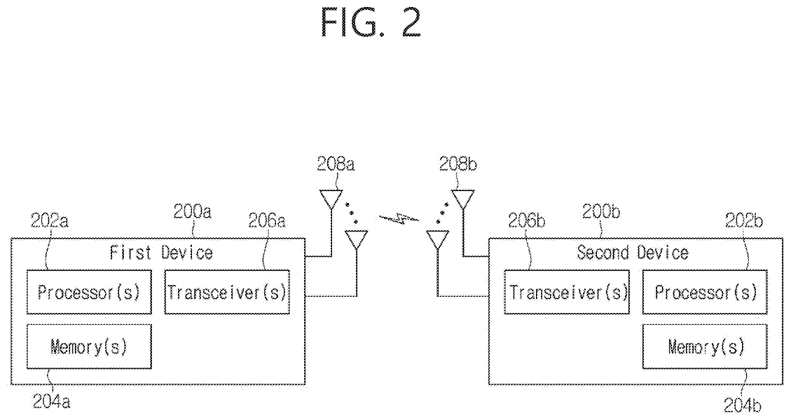

FIG. 2 shows an example of a wireless device applicable to the present disclosure.

Referring to FIG. 2, a first wireless device 200 a and a second wireless device 200 b may transmit and receive radio signals through various radio access technologies (e.g., LTE or NR). Here, (the first wireless device 200 a, the second wireless device 200 b) may correspond to (the wireless device 100 x, the base station 120) and/or (the wireless device 100 x, the wireless device 100 x) of FIG. 1.

The first wireless device 200 a may include one or more processors 202 a and one or more memories 204 a and may further include one or more transceivers 206 a and/or one or more antennas 208 a. The processor 202 a may be configured to control the memory 204 a and/or the transceiver 206 a and to implement descriptions, functions, procedures, proposals, methods and/or operational flowcharts disclosed herein. For example, the processor 202 a may process information in the memory 204 a to generate first information/signal and then transmit a radio signal including the first information/signal through the transceiver 206 a. In addition, the processor 202 a may receive a radio signal including second information/signal through the transceiver 206 a and then store information obtained from signal processing of the second information/signal in the memory 204 a. The memory 204 a may be coupled with the processor 202 a, and store a variety of information related to operation of the processor 202 a. For example, the memory 204 a may store software code including instructions for performing all or some of the processes controlled by the processor 202 a or performing the descriptions, functions, procedures, proposals, methods and/or operational flowcharts disclosed herein. Here, the processor 202 a and the memory 204 a may be part of a communication modem/circuit/chip designed to implement wireless communication technology (e.g., LTE or NR). The transceiver 206 a may be coupled with the processor 202 a to transmit and/or receive radio signals through one or more antennas 208 a. The transceiver 206 a may include a transmitter and/or a receiver. The transceiver 206 a may be used interchangeably with a radio frequency (RF) unit. In the present disclosure, the wireless device may refer to a communication modem/circuit/chip.

The second wireless device 200 b may include one or more processors 202 b and one or more memories 204 b and may further include one or more transceivers 206 b and/or one or more antennas 208 b. The processor 202 b may be configured to control the memory 204 b and/or the transceiver 206 b and to implement the descriptions, functions, procedures, proposals, methods and/or operational flowcharts disclosed herein. For example, the processor 202 b may process information in the memory 204 b to generate third information/signal and then transmit the third information/signal through the transceiver 206 b. In addition, the processor 202 b may receive a radio signal including fourth information/signal through the transceiver 206 b and then store information obtained from signal processing of the fourth information/signal in the memory 204 b. The memory 204 b may be coupled with the processor 202 b to store a variety of information related to operation of the processor 202 b. For example, the memory 204 b may store software code including instructions for performing all or some of the processes controlled by the processor 202 b or performing the descriptions, functions, procedures, proposals, methods and/or operational flowcharts disclosed herein. Herein, the processor 202 b and the memory 204 b may be part of a communication modem/circuit/chip designed to implement wireless communication technology (e.g., LTE or NR). The transceiver 206 b may be coupled with the processor 202 b to transmit and/or receive radio signals through one or more antennas 208 b. The transceiver 206 b may include a transmitter and/or a receiver. The transceiver 206 b may be used interchangeably with a radio frequency (RF) unit. In the present disclosure, the wireless device may refer to a communication modem/circuit/chip.

Hereinafter, hardware elements of the wireless devices 200 a and 200 b will be described in greater detail. Without being limited thereto, one or more protocol layers may be implemented by one or more processors 202 a and 202 b. For example, one or more processors 202 a and 202 b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202 a and 202 b may generate one or more protocol data units (PDUs) and/or one or more service data unit (SDU) according to the descriptions, functions, procedures, proposals, methods and/or operational flowcharts disclosed herein. One or more processors 202 a and 202 b may generate messages, control information, data or information according to the descriptions, functions, procedures, proposals, methods and/or operational flowcharts disclosed herein. One or more processors 202 a and 202 b may generate PDUs. SDUs, messages, control information, data or information according to the functions, procedures, proposals and/or methods disclosed herein and provide the PDUs, SDUs, messages, control information, data or information to one or more transceivers 206 a and 206 b. One or more processors 202 a and 202 b may receive signals (e.g., baseband signals) from one or more transceivers 206 a and 206 b and acquire PDUs, SDUs, messages, control information, data or information according to the descriptions, functions, procedures, proposals, methods and/or operational flowcharts disclosed herein.

One or more processors 202 a and 202 b may be referred to as controllers, microcontrollers, microprocessors or microcomputers. One or more processors 202 a and 202 b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202 a and 202 b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202 a and 202 b or stored in one or more memories 204 a and 204 b to be driven by one or more processors 202 a and 202 b. The descriptions, functions, procedures, proposals, methods and/or operational flowcharts disclosed herein implemented using firmware or software in the form of code, a command and/or a set of commands.

One or more memories 204 a and 204 b may be coupled with one or more processors 202 a and 202 b to store various types of data, signals, messages, information, programs, code, instructions and/or commands. One or more memories 204 a and 204 b may be composed of read only memories (ROMs), random access memories (RAMs), erasable programmable read only memories (EPROMs), flash memories, hard drives, registers, cache memories, computer-readable storage mediums and/or combinations thereof. One or more memories 204 a and 204 b may be located inside and/or outside one or more processors 202 a and 202 b. In addition, one or more memories 204 a and 204 b may be coupled with one or more processors 202 a and 202 b through various technologies such as wired or wireless connection.

One or more transceivers 206 a and 206 b may transmit user data, control information, radio signals/channels, etc. described in the methods and/or operational flowcharts of the present disclosure to one or more other apparatuses. One or more transceivers 206 a and 206 b may receive user data, control information, radio signals/channels, etc. described in the methods and/or operational flowcharts of the present disclosure from one or more other apparatuses. For example, one or more transceivers 206 a and 206 b may be coupled with one or more processors 202 a and 202 b to transmit/receive radio signals. For example, one or more processors 202 a and 202 b may perform control such that one or more transceivers 206 a and 206 b transmit user data, control information or radio signals to one or more other apparatuses. In addition, one or more processors 202 a and 202 b may perform control such that one or more transceivers 206 a and 206 b receive user data, control information or radio signals from one or more other apparatuses. In addition, one or more transceivers 206 a and 206 b may be coupled with one or more antennas 208 a and 208 b, and one or more transceivers 206 a and 206 b may be configured to transmit/receive user data, control information, radio signals/channels, etc. described in the descriptions, functions, procedures, proposals, methods and/or operational flowcharts disclosed herein through one or more antennas 208 a and 208 b. In the present disclosure, one or more antennas may be a plurality of physical antennas or a plurality of logical antennas (e.g., antenna ports). One or more transceivers 206 a and 206 b may convert the received radio signals/channels, etc. from RF band signals to baseband signals, in order to process the received user data, control information, radio signals/channels, etc. using one or more processors 202 a and 202 b. One or more transceivers 206 a and 206 b may convert the user data, control information, radio signals/channels processed using one or more processors 202 a and 202 b from baseband signals into RF band signals. To this end, one or more transceivers 206 a and 206 b may include (analog) oscillator and/or filters.

### Structure of Wireless Device Applicable to the Present Disclosure

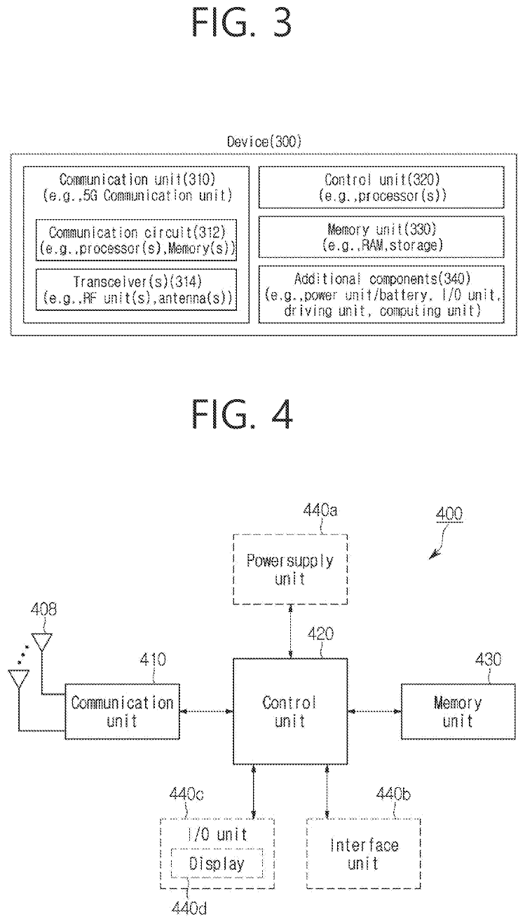

FIG. 3 shows another example of a wireless device applicable to the present disclosure.

Referring to FIG. 3, a wireless device 300 may correspond to the wireless devices 200 a and 200 b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202 b and/or one or more memories 204 a and 204 b of FIG. 2. For example, the transceiver(s) 314 may include one or more transceivers 206 a and 206 b and/or one or more antennas 208 a and 208 b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100 a), the vehicles (FIG. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440 a, an interface unit (interface) 440 b, and an input/output unit 440 c. An antenna unit (antenna) 408 may be part of the communication unit 410. The blocks 410 to 430/440 a to 440 c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440 a may supply power to the hand-held device 400 and include a wired/wireless charging circuit, a battery, etc. The interface unit 440 b may support connection between the hand-held device 400 and another external device. The interface unit 440 b may include various ports (e.g., an audio input/output port and a video input/output port) for connection with the external device. The input/output unit 440 c may receive or output video information/signals, audio information/signals, data and/or user input information. The input/output unit 440 c may include a camera, a microphone, a user input unit, a display 440 d, a speaker and/or a haptic module.

For example, in case of data communication, the input/output unit 440 c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440 c in various forms (e.g., text, voice, image, video and haptic).

### Type of Wireless Device Applicable to the Present Disclosure

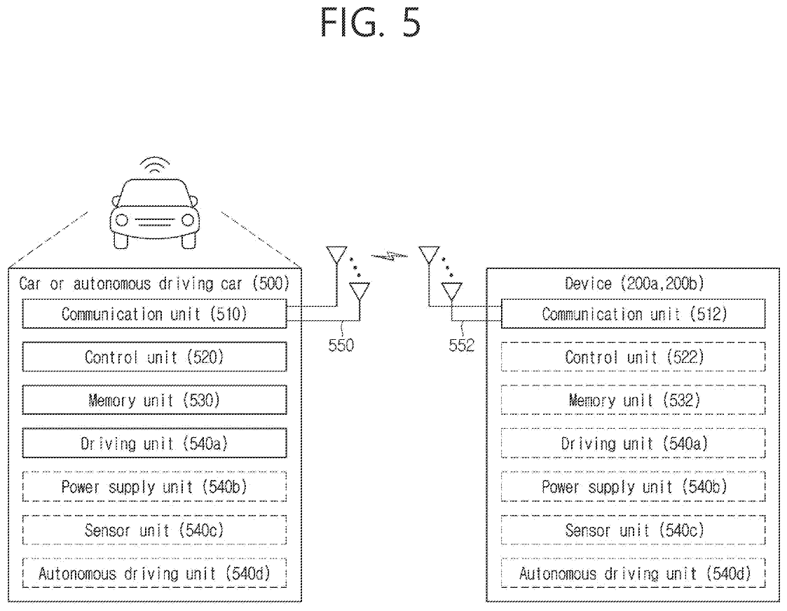

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540 a, a power supply unit (power supply) 540 b, a sensor unit 540 c, and an autonomous driving unit 540 d. The antenna unit 550 may be configured as part of the communication unit 510. The blocks 510/530/540 a to 540 d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

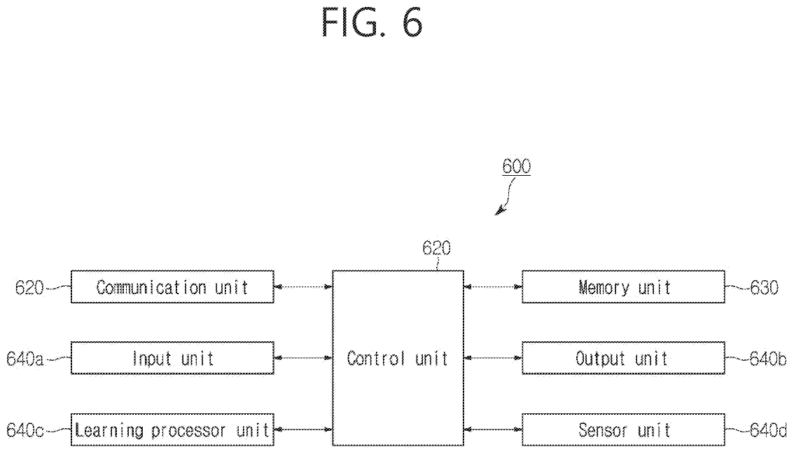

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640 c and a sensor unit 640 d. The blocks 610 to 630/640 a to 640 d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100 x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640 c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640 c or transmit the history information to the AI server (FIG. 1, 140). The collected history information may be used to update a learning model.

The memory unit 630 may store data supporting various functions of the AI device 600. For example, the memory unit 630 may store data obtained from the input unit 640 a, data obtained from the communication unit 610, output data of the learning processor unit 640 c, and data obtained from the sensing unit 640. In addition, the memory unit 630 may store control information and/or software code necessary to operate/execute the control unit 620.

The input unit 640 a may acquire various types of data from the outside of the AI device 600. For example, the input unit 640 a may acquire learning data for model learning, input data, to which the learning model will be applied, etc. The input unit 640 a may include a camera, a microphone and/or a user input unit. The output unit 640 b may generate video, audio or tactile output. The output unit 640 b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640 c may train a model composed of an artificial neural network using training data. The learning processor unit 640 c may perform AI processing along with the learning processor unit of the AI server (FIG. 1, 140). The learning processor unit 640 c may process information received from an external device through the communication unit 610 and/or information stored in the memory unit 630. In addition, the output value of the learning processor unit 640 c may be transmitted to the external device through the communication unit 610 and/or stored in the memory unit 630.

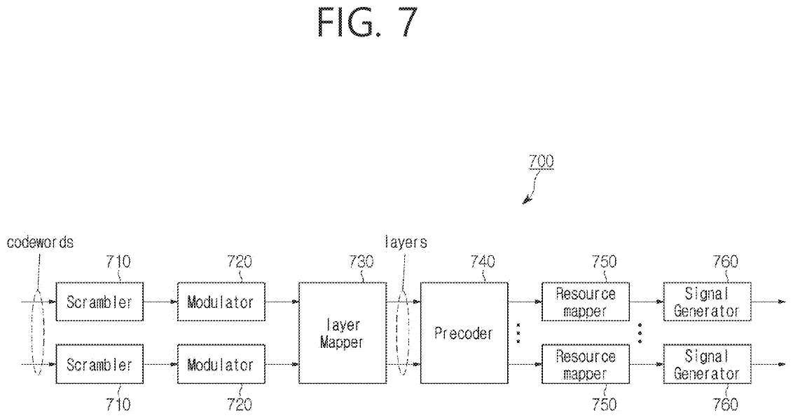

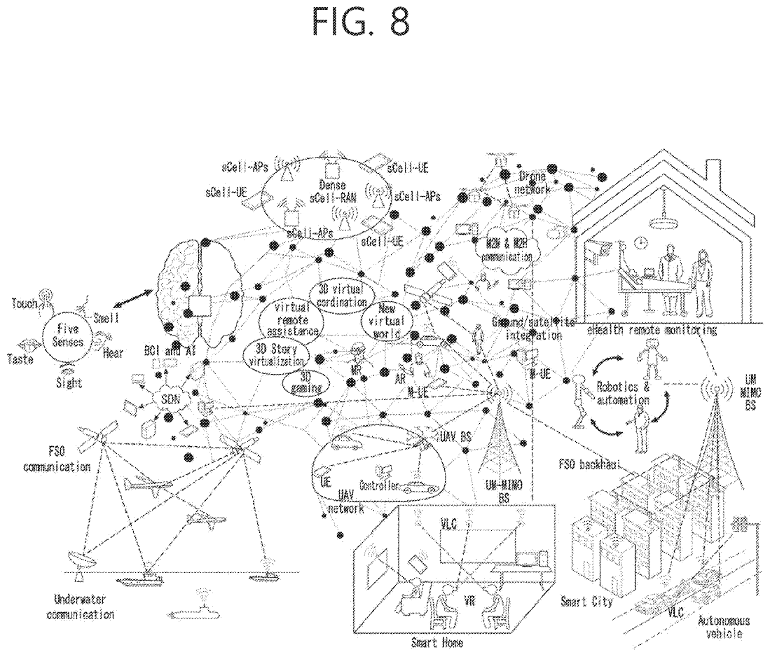

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202 a and 202 b and/or the transceiver 206 a and 206 b of FIG. 2. In addition, for example, the hardware element of FIG. 7 may be implemented in the processors 202 a and 202 b of FIG. 2 and/or the transceivers 206 a and 206 b of FIG. 2. For example, blocks 710 to 760 may be implemented in the processors 202 a and 202 b of FIG. 2. In addition, blocks 710 to 750 may be implemented in the processors 202 a and 202 b of FIG. 2 and a block 760 may be implemented in the transceivers 206 a and 206 b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200 a or 200 b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. For example, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

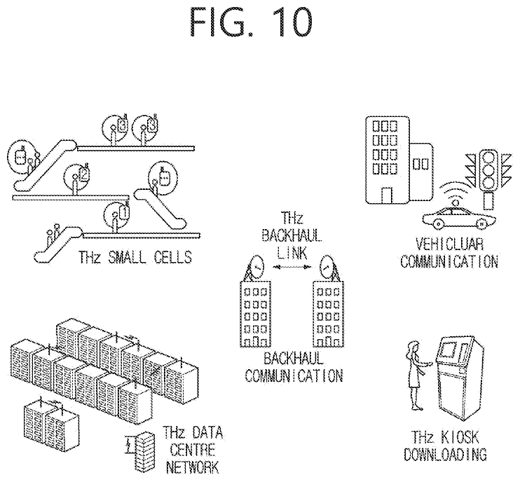

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The technology most important to and newly introduced in a sixth-generation (6G) system is artificial intelligence (AI). Artificial intelligence (AI) was not involved in a fourth-generation (4G) system. A fifth-generation (5G) system will support partial or very limited AI. However, a 6G system will support AI for full automation. Advances in machine learning will make the network more intelligent for real-time communication in 6G. Introducing AI into communication can streamline and improve real-time data transmission. AI can determine how complex target tasks are performed by using numerous analyses. For example, AI can improve efficiency and reduce processing latency.

Time-consuming tasks such as handover, network selection, and resource scheduling may be performed immediately by using AI. AI may also play an important role in machine-to-machine (M2M), machine-to-human, and human-to-machine communications. In addition, AI may enable rapid communication in a brain computer interface (BCI). An AI-based communication system may be supported by meta-materials, intelligent structures, intelligent networks, intelligent devices, intelligent cognitive radio, self-sustaining wireless networks, and machine learning.

Recently, attempts have emerged to integrate AI with a wireless communication system, however, these have focused on an application layer and a network layer, in particular, deep learning has been focused on wireless resource management and allocation. However, such research is gradually evolving to a medium access control (MAC) layer and a physical (PHY) layer, and especially attempts are appearing to combine deep learning with wireless transmission in the PHY layer. AI-based PHY-layer transmission means that, in fundamental signal processing and communication mechanisms, an AI-driven signal processing and communication mechanism is applied instead of a traditional communication framework. For example, it may include deep-learning-based channel coding and decoding, deep-learning-based estimation and detection, deep-learning-based multiple input multiple output (MIMO) mechanism, and AI-based resource scheduling and allocation.

Machine learning may be used for channel estimation and channel tracking, and may be used for power allocation and interference cancellation in a downlink (DL) PHY layer. In addition, machine learning may be used for antenna selection, power control, and symbol detection in a MIMO system.

However, applying a deep neural network (DNN) for transmission in the PHY layer may have problems as below.

A deep-learning-based AI algorithm requires numerous training data to optimize training parameters. However, due to a limitation in obtaining data as training data in a specific channel environment, a large amount of training data is used offline. This static training of training data in a specific channel environment may contradict a dynamic characteristic and diversity of a wireless channel.

In addition, current deep learning mainly targets a real signal. However, signals of the PHY layer of wireless communication are complex signals. Further research is required on a neural network that detects a signal in a complex domain to match characteristics of a wireless communication signal.

Hereinafter, machine learning will be considered in more detail.

Machine learning means a series of operations that train a machine to create a machine that can perform tasks that a human can do or is difficult to do. For machine learning, data and a learning model are required. A data learning method in machine learning may be largely classified into three types, for example, supervised learning, unsupervised learning, and reinforcement learning.

Neural-network learning aims to minimize an error of an output. Neural-network learning is a process of repeatedly inputting training data to a neural network, calculating an error between an output of the neural network for the training data and a target, and backpropagating the error from an output layer of the neural network toward an input layer to update a weight of each node of the neural network in a direction to reduce the error.

Supervised learning uses training data labeled with correct answers, and unsupervised learning may use training data not labeled with correct answers. For example, for example, in supervised learning on data classification, training data may be data in which a category is labeled to each training datum. The labeled training data are input to a neural network, and an error is calculated by comparing an output (category) of the neural network with a label of the training data. The calculated error is backpropagated in a reverse direction (for example, from the output layer toward the input layer) in the neural network, and a connection weight of each node of each layer of the neural network may be updated according to the backpropagation. A change amount of a connection weight of each node to be updated may be determined according to a learning rate. A calculation of the neural network for input data and a backpropagation of the error may constitute a learning cycle (epoch). The learning rate may be applied differently according to the number of repetitions of learning cycles of the neural network. For example, in an early stage of learning of the neural network, a high learning rate is used to allow the neural network to quickly secure a certain level of performance to improve efficiency, and in a later stage of learning, a low learning rate may be used to improve accuracy.

A learning method may vary depending on characteristics of data. For example, when the purpose in a communication system is to accurately predict, at a receiving end, data transmitted at a transmitting end, it is preferable to perform learning by using supervised learning rather than unsupervised learning or reinforcement learning.

A learning model corresponds to a human brain; although a most basic linear model may be considered, a paradigm of machine learning that uses a neural-network structure with high complexity, such as artificial neural networks, as a learning model is called deep learning.

As a neural-network core used as a learning method, there are largely deep neural networks (DNN), convolutional neural networks (CNN), and a recurrent boltzmann machine (RNN) method, and such learning models may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

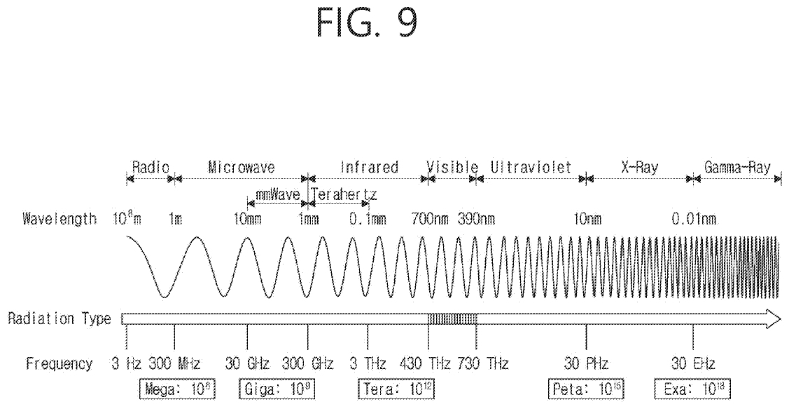

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiments of the Disclosure

The present disclosure relates to radar-communication by using a virtual receive array in a wireless communication system. Specifically, the present disclosure relates to a technology for performing wireless communication and radar sensing by using the same hardware, and performing a radar operation by using a virtual receive array. In particular, the present disclosure proposes various embodiments for an operation of radar-communication utilizing a time division duplex (TDD) scheme.

The present disclosure may be used to build a wireless radar-communication network applicable not only to various existing communication systems but also to a sixth-generation (6G) system and a system beyond 6G. Furthermore, by utilizing a wasted virtual array element of a transceiver-integrated type proposed herein, a technology for mitigating an ambiguity due to received signal distortion during a radar operation of a virtual array may be used to enhance radar performance without degradation of communication performance.

Recently, radar-communication systems that support radar and communication simultaneously by using one hardware have been actively studied. As a frequency used for a communication system increases to a millimeter wave (mmWave) frequency, frequencies for communication and for radar become similar to each other, and functions configured by hardware in the past are being replaced with a signal-processing domain. A radar-communication system may be widely applied to an intelligent transportation platform, a sensor network, and autonomous driving, which require both a communication link with another vehicle and radar sensing.

A structure of radar and a communication system currently used has a limitation in operating radar-communication simultaneously. As a duplex method for communication, a TDD scheme may be used. TDD is a sharing scheme of a transmitting/receiving antenna that switches transmission and reception in a time axis. When the TDD scheme is used, an antenna is shared. Accordingly, a size of a system module is reduced and, unlike when a transmitting antenna and a receiving antenna are separated, channel estimation for communication becomes simple.

However, unlike communication, radar requires transmission and reception to proceed simultaneously, and therefore the TDD scheme is unsuitable for use in radar. Although a TDD-scheme radar is not impossible to implement, in some cases a detection algorithm requires performing transmission and reception simultaneously. In addition, a reception-unavailable time due to transmit/receive switching may act as a performance limit of radar, and therefore, for radar, a full-duplex scheme is more suitable than a TDD scheme. For example, it is preferable that radar operates in a full duplex scheme. In a MIMO radar or a phased-subarray MIMO radar operating in a full-duplex scheme, antennas of a transmitter and a receiver are designed to be separated from each other. However, such a structure increases a size of a radio frequency (RF) system module and requires channel estimation for each of the transmitting antenna and the receiving antenna in a communication process, and thus is not suitable for use in a radar-communication system.

As a scheme for solving this, a technique of simultaneously using one transmitting/receiving antenna by using a circulator has been proposed. However, when a circulator is used, as an operating frequency increases, an isolation problem occurs, and this is also unsuitable for use in a radar-communication convergence structure.

Accordingly, the present disclosure proposes a MIMO radar sensing technology using a TDD scheme suitable for a radar-communication system, by reducing a module size and facilitating channel estimation by utilizing a sharing structure of transmitting/receiving antennas. In addition, the present disclosure proposes a scheme for mitigating an ambiguity problem due to received signal distortion of a virtual-array MIMO radar in an operation method of radar-communication utilizing a TDD scheme.

The most important performance of radar is a capability of accurately detecting even a small object. However, back scattering reflected from a target varies according to various factors of the target (e.g., shape, dielectric property, frequency, incidence angle, polarization) and a scattering type (e.g., surface scattering, bounce scattering, volume scattering), and therefore radar performance varies depending on the target and a use environment. In addition, due to various natural phenomena such as a Faraday rotation effect in which, when frequency decreases, rotation increases when a linearly polarized electromagnetic wave passes through an ionosphere and, when frequency increases, rotation decreases when a linearly polarized electromagnetic wave passes through the ionosphere, a received signal distortion phenomenon will occur.

Typical polarizations that a single radar can provide include horizontal/vertical polarization, linear 45 degree/linear −45 degree polarization, and left circular/right circular polarization. In double bounce scattering, a parallel polarization (e.g., horizontal polarization, vertical polarization) content is advantageous, in surface scattering, a diagonal polarization (e.g., +45-degree polarization, −45-degree polarization) is advantageous, and in volume scattering, a circular polarization is advantageous; however, it is not easy to implement a radar sensor capable of providing all these polarizations. To obtain more polarized mode data for improving radar performance, a radar that provided one polarized mode (e.g., H/H, H/V, V/H, or V/V) is designed to provide up to four polarized modes (e.g., H/H. H/V, V/H, V/V).

A virtual array is a subject being studied as an alternative to a method of increasing a number of antenna elements from a hardware viewpoint, as a scheme to increase range resolution; however, a virtual array has a phase distortion problem. In particular, in a transmit/receive-separated type, although range resolution can be greatly improved, an ambiguity problem due to received signal distortion occurs and, as a result, detection quality of a moving target may be degraded. In contrast, in a transceiver-integrated type, in addition to an ambiguity problem due to received signal distortion, a redundant virtual array problem in which improvement in range resolution is insufficient compared with the separated type also exists. Accordingly, the present disclosure intends to propose a reconfigurable virtual array and an operation scheme therefor to efficiently utilize virtual antenna elements of the transceiver-integrated type.

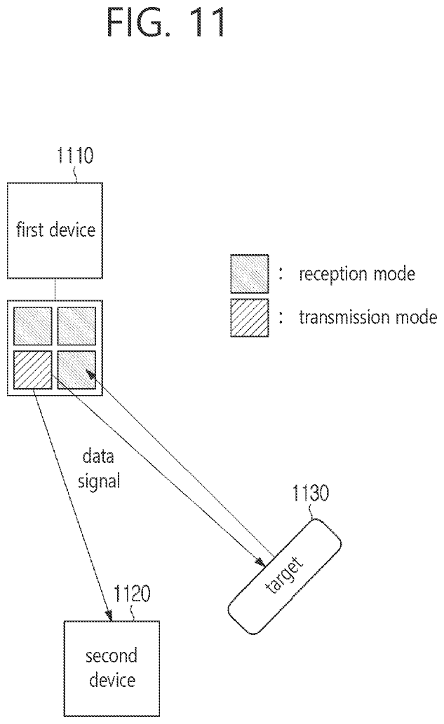

First, concepts of a radar operation and a communication operation ina radar-communication system are as follows. FIG. 11 shows a concept of a radar-communication operation, based on an embodiment of the present disclosure. FIG. 11 illustrates a situation in which a first device (1110) having a radar function performs communication with a second device (1120) while sensing a target (1130).

Referring to FIG. 11, the first device (1110) transmits a data signal by using an antenna array. Here, the array antenna includes a plurality of subarrays, and each subarray may operate in a transmission mode or a reception mode. The data signal includes data and/or information to be transmitted to the second device (1110). The second device (1110) performs communication with the first device (1110) by receiving the data signal. For example, the data signal transmits data and/or information to the second device (1110).

In addition, the data signal may be reflected by the target (1130). A signal reflected by the target (1130) is received through at least one subarray operating in a reception mode of the first device (1110). For example, the first device (1110) may receive, through at least one subarray operating in the reception mode, a reflected signal corresponding to the data signal transmitted through at least one subarray operating in the transmission mode. For this, a transmitter and a receiver of the first device (1110) may operate simultaneously in a full duplex scheme. The first device (1110) may perform a radar operation to sense the target (1130) by using the reflected signal.

As described above, a device (e.g., the first device (1110)) according to various embodiments of the present disclosure may perform a radar operation by using a data signal that is not a signal designed for separate radar sensing. Accordingly, a communication operation and a radar operation may be performed by using the same signals. In this case, if necessary, when generating the data signal, additional processing for use as a radar signal may be performed. In FIG. 11, the target device (1130) is described as a device different from the second device (1120) that performs communication; however, depending on a situation, the second device (1120) may be a target device and become a target of the radar operation.

Concept and operating principle of a MIMO radar are as follows.

A MIMO radar is a radar consisting of multiple transmitting antennas and multiple receiving antennas. A MIMO radar consisting of Nt transmitting antennas and Nr receiving antennas can provide the same performance as a radar using Nt×Nr receiving antennas. Therefore, a MIMO radar may be used as an efficient technology capable of improving an angular resolution of radar.

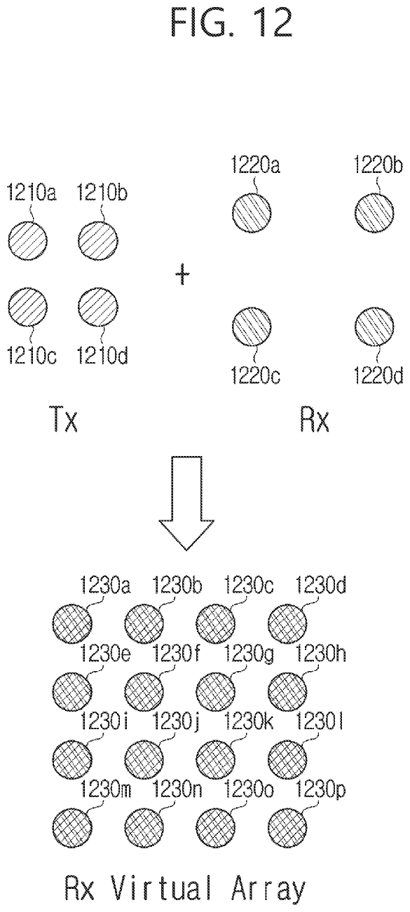

FIG. 12 shows a concept of a MIMO radar, based on an embodiment of the present disclosure. FIG. 12 exemplifies how a virtual antenna array for a radar operation is formed in a MIMO radar device including four transmitting antennas (1210a to 1210d) and four receiving antennas (1220a to 1220d). Each of the transmitting antennas (1210a to 1210d) forms a different phase array with respect to the four receiving antennas (1220a to 1220d). Since a distance between the transmitting antennas (1210a to 1210d) generates an additional phase shift with respect to the receiving antennas (1220a to 1220d), phase arrays (1231 to 1233) formed at the respective transmitting antennas (1210a to 1210d) are formed with differences by the distance between the transmitting antennas (1210a to 1210d). As a result, a MIMO radar having a 4×4 antenna configuration can form a virtual receive antenna array including sixteen antenna elements (1230a to 1230p).

Unlike a phased-array radar transmitting one waveform, since multiple signals can be transmitted by using multiple antennas, a MIMO radar has diversity in a transmission waveform. Due to such diversity, a MIMO radar provides excellent performance in some aspects. First, when signals are transmitted by using Mt transmitting antennas in a MIMO radar, a number of targets that can be detected also increases by Mt times. This is because a virtual antenna aperture size becomes Mt times larger by a virtual antenna array configured by the MIMO radar. In addition, a MIMO radar enables better resolution and interference cancellation by utilizing adaptive techniques. If transmitted signals are independent of each other, signals returning after being reflected by multiple targets also have linear independence. Due to this property, appropriate techniques for determining a position of a target can be flexibly applied in a signal-processing stage.

An operation of radar-communication utilizing a TDD scheme is as follows.

A general MIMO radar has a structure in which transmitting antennas and receiving antennas are separated. This is because, at a high frequency, isolation performance of a circulator is not sufficiently secured, and it is difficult to implement a structure that shares antennas for transmission and reception. However, the present disclosure proposes a scheme of performing a radar operation by utilizing MIMO radar technology in a structure that shares antennas for transmission and reception.

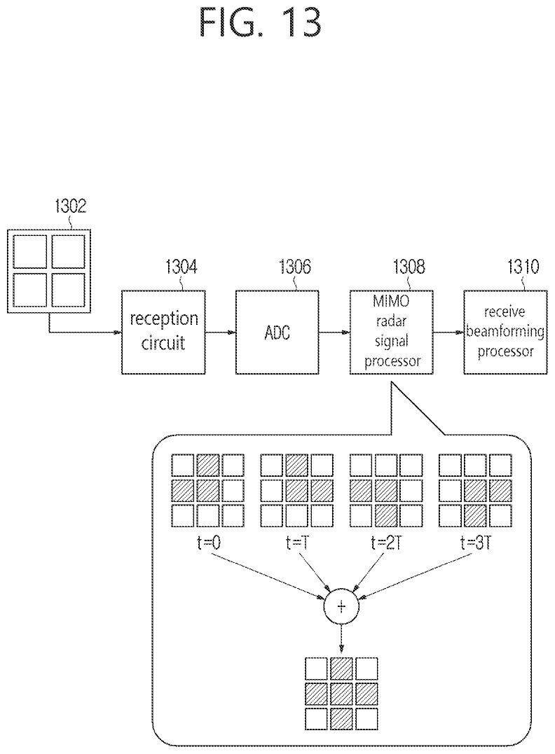

FIG. 13 shows a functional structure of a device for forming a virtual array, based on an embodiment of the present disclosure. FIG. 13 exemplifies a structure in which four subarrays are used. However, the structure of FIG. 13 may be applied to a structure using more subarrays.

Referring to FIG. 13, the device includes an antenna array (1302), a reception circuit (1304), an analog-to-digital converter (ADC) (1306), a MIMO radar signal processor (1308), and a receive beamforming processor (1310).

The antenna array (1302) includes a plurality of subarrays. For example, the subarrays may be arranged in a 2×2 structure. Each of the subarrays includes at least one antenna element. According to an embodiment, each subarray may be used in a transmission mode or a reception mode. Specifically, among the plurality of subarrays, some may be used for the transmission mode, and the remainder may be used for the reception mode.

The reception circuit (1304) processes signals received through the array antenna (1302). For example, the reception circuit (1304) includes a filter, an amplifier, and a mixer, and may amplify a received signal and convert the received signal into an intermediate-band or baseband signal. Here, the reception circuit (1304) processes signals received through at least one subarray operating in the reception mode among the subarrays included in the antenna array (1302). The ADC (1306) converts an analog signal output from the reception circuit (1304) into a digital signal.

The MIMO radar signal processor (1308) forms a virtual receive array for a MIMO radar operation based on signals received and processed during a plurality of time slots or time occasions. For example, the MIMO radar signal processor (1308) places signals received through different combinations of subarrays at four time occasions t=0, T, 2T, and 3T in a virtual receive array and, by combining the placed signals, may obtain signals received through the virtual receive array. In this case, according to an embodiment, an aperture of the virtual receive array may be larger than an aperture of the array antenna (1302).

The receive beamforming processor (1310) performs receive beamforming based on the virtual receive array formed by the MIMO radar signal processor (1308). For example, the receive beamforming processor (1310) may perform receive beamforming on signals generated according to the virtual receive array. For example, the receive beamforming processor (1310) may perform receive beamforming on virtual signals, which are treated as if they were received during one time occasion, by combining signals received during the plurality of time occasions according to the virtual receive array. Accordingly, a signal may be obtained for the radar operation.

According to the structure of FIG. 13, a virtual receive array may be formed. In the present disclosure, a virtual array of a MIMO structure may be determined by a matrix convolution of transmitting antennas and receiving antennas. For example, in an antenna having a 2×2 subarray structure, a result of determining a virtual array in a TDD-based radar-communication operation technology applied thereto may be represented as in Table 21 below.

TABLE 2

| t = 0 | t = T | t = 2T | t = 3T | Total |
|---|---|---|---|---|
| $( \begin{matrix}1 & 0 \\ 0 & 0\end{matrix} ) \times ( \begin{matrix}0 & 1 \\ 1 & 1\end{matrix} ) = ( \begin{matrix}0 & 1 & 0 \\ 1 & 1 & 0 \\ 0 & 0 & 0\end{matrix} )$ | $( \begin{matrix}0 & 1 \\ 0 & 0\end{matrix} ) \times ( \begin{matrix}1 & 0 \\ 1 & 1\end{matrix} ) = ( \begin{matrix}0 & 1 & 0 \\ 0 & 1 & 1 \\ 0 & 0 & 0\end{matrix} )$ | $( \begin{matrix}0 & 0 \\ 1 & 0\end{matrix} ) \times ( \begin{matrix}1 & 1 \\ 0 & 1\end{matrix} ) = ( \begin{matrix}0 & 0 & 0 \\ 1 & 1 & 0 \\ 0 & 1 & 0\end{matrix} )$ | $( \begin{matrix}0 & 0 \\ 0 & 1\end{matrix} ) \times ( \begin{matrix}1 & 1 \\ 1 & 0\end{matrix} ) = ( \begin{matrix}0 & 0 & 0 \\ 0 & 1 & 1 \\ 0 & 1 & 0\end{matrix} )$ | $( \begin{matrix}0 & 2 & 0 \\ 2 & 4 & 2 \\ 0 & 2 & 0\end{matrix} )$ |

By combining all receive arrays formed at t=0 to 3T as in [Table 2], a final virtual receive array may be formed.

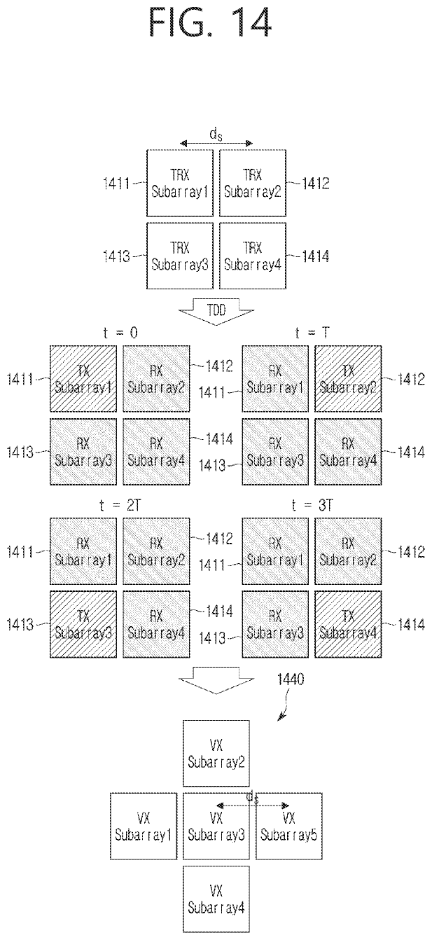

FIG. 14 shows an example of a virtual array formed by using antennas shared in a TDD scheme, based on an embodiment of the present disclosure. For example, FIG. 14 exemplifies a technique of sharing a transmitting antenna and a receiving antenna in a TDD scheme by using an antenna structure consisting of a plurality of subarrays. Referring to FIG. 14, the antenna array has a 2×2 subarray structure composed of subarray 1 (1411), subarray 2 (1412), subarray 3 (1413), and subarray 4 (1414). Each of the subarrays (1411 to 1414) includes at least one antenna element and is connected to a front end of a transmitter and a receiver including a switch. Each of the subarrays (1411 to 1414) may include one antenna element, in which case each of the subarrays (1411 to 1414) may be understood as a single antenna.

When the TDD scheme is applied in the structure of FIG. 14, each of the subarrays (1411 to 1414) may be used as transmitting antennas according to time. For example, during a radar pulse duration T, the device uses only one of the subarrays (1411 to 1414) for a transmitter, and uses the remaining subarrays for a receiver. This operation is repeated for all transmitters. Specifically, at t=0, a signal is transmitted through the subarray 1 (1411), and a reflected signal is received through the subarray 2 (1412), the subarray 3 (1413), and the subarray 4 (1414). At t=T, a signal is transmitted through the subarray 2 (1412), and a reflected signal is received through the subarray 1 (1411), the subarray 3 (1413), and the subarray 4 (1414). At t=2T, a signal is transmitted through the subarray 3 (1413), and a reflected signal is received through the subarray 1 (1411), the subarray 2 (1412), and the subarray 4 (1414). At t=3T, a signal is transmitted through the subarray 4 (1414), and a reflected signal is received through the subarray 1 (1411), the subarray 2 (1412), and the subarray 3 (1413). Thereafter, when virtual receive arrays formed at the receivers are combined, a final virtual receive array (1440) may be formed. A TDD operation of antenna subarrays for forming the virtual receive array (1440) as in FIG. 14 may be controlled as in [Table 3] below.

TABLE 3

| | t = 0 | t = T | t = 2T | t = 3T |
|---|---|---|---|---|
| Subarray #1 | TX | RX | RX | RX |
| | (downlink) | (Uplink) | (Uplink) | (Uplink) |
| Subarray #2 | RX | TX | RX | RX |
| | (Uplink) | (downlink) | (Uplink) | (Uplink) |
| Subarray #3 | RX | RX | TX | RX |
| | (Uplink) | (Uplink) | (downlink) | (Uplink) |
| Subarray #4 | RX | RX | RX | TX |
| | (Uplink) | (Uplink) | (Uplink) | (downlink) |

[Table 3] shows operating states of subarrays in a case where a base station is a subject that performs a communication-radar operation. As in [Table 2], each subarray is used in a TDD scheme. However, from a viewpoint of the device, since transmission and reception are both performed by using different subarrays at each time point, it may be understood as a full-duplex scheme.

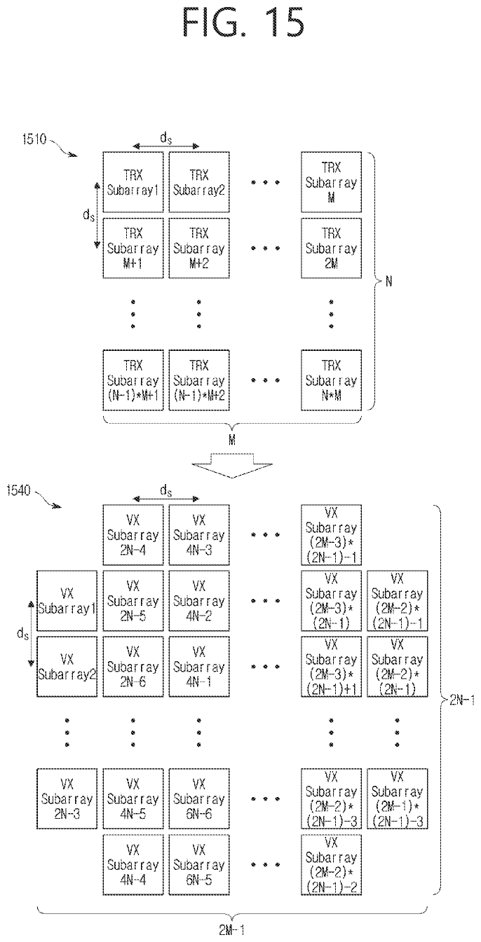

When a size of a transmit/receive subarray array is generalized to N×M, a virtual receive array may be formed as in FIG. 15. FIG. 15 shows another example of a virtual receive array formed by using antennas shared in a TDD scheme, based on an embodiment of the present disclosure. Referring to FIG. 15, from a transmit/receive subarray array (1510) of a size N×M, a virtual receive array (1540) of a size (2N−1)×(2M−1) may be formed. For example, a virtual receive array of a size about two times larger than an actual subarray array may be formed. For example, as in FIG. 15, a MIMO radar that forms a virtual receive array of a size (2N−1)×(2M−1) by using N×M subarrays may be built.

In a case of a virtual array of a MIMO structure described above, when a polarization of a signal is considered, a matrix product of a transmitting antenna and a receiving antenna may be represented as in [Table 4] or [Table 5] below. Here, polarization means a polarity direction of an electric field of a signal with respect to a propagation direction of an electromagnetic wave, and includes a linear polarization (e.g., horizontal polarization, vertical polarization) and a circular polarization (e.g., right-hand circular polarization, left-hand circular polarization). In [Table 4] and [Table 5] below, R denotes right-hand circular polarization, and D denotes a dual polarization including a horizontal polarization and a vertical polarization.

TABLE 4

| t = 0 | t = T | t = 2T | t = 3T | Total |
|---|---|---|---|---|
| $( \begin{matrix}R & 0 \\ 0 & 0\end{matrix} ) \times ( \begin{matrix}0 & R \\ R & R\end{matrix} ) = ( \begin{matrix}0 & R & 0 \\ R & R & 0 \\ 0 & 0 & 0\end{matrix} )$ | $( \begin{matrix}0 & R \\ 0 & 0\end{matrix} ) \times ( \begin{matrix}R & 0 \\ R & R\end{matrix} ) = ( \begin{matrix}0 & R & 0 \\ 0 & R & R \\ 0 & 0 & 0\end{matrix} )$ | $( \begin{matrix}0 & 0 \\ R & 0\end{matrix} ) \times ( \begin{matrix}R & R \\ 0 & R\end{matrix} ) = ( \begin{matrix}0 & 0 & 0 \\ R & R & 0 \\ 0 & R & 0\end{matrix} )$ | $( \begin{matrix}0 & 0 \\ 0 & R\end{matrix} ) \times ( \begin{matrix}R & R \\ R & 0\end{matrix} ) = ( \begin{matrix}0 & 0 & 0 \\ 0 & R & R \\ 0 & R & 0\end{matrix} )$ | $( \begin{matrix}0 & RR & 0 \\ RR & RRRR & RR \\ 0 & RR & 0\end{matrix} )$ |

In the case of [Table 4], right-hand circular polarization is used for transmission and right-hand circular polarization is used for reception. In the present disclosure, such polarization use as in [Table 4] is expressed as R/R, and information specifying a polarization for transmission and a polarization for reception, such as R/R, is referred to as a polarization mode. For example, [Table 4] shows an example of operation of a polarization mode R/R.

TABLE 5

| t = 0 | t = T | t = 2T |
|---|---|---|
| $( \begin{matrix}D & 0 \\ 0 & 0\end{matrix} ) \times ( \begin{matrix}0 & D \\ D & D\end{matrix} ) = ( \begin{matrix}0 & D & 0 \\ D & D & 0 \\ 0 & 0 & 0\end{matrix} )$ | $( \begin{matrix}0 & D \\ 0 & 0\end{matrix} ) \times ( \begin{matrix}D & 0 \\ D & D\end{matrix} ) = ( \begin{matrix}0 & D & 0 \\ 0 & D & D \\ 0 & 0 & 0\end{matrix} )$ | $( \begin{matrix}0 & 0 \\ D & 0\end{matrix} ) \times ( \begin{matrix}D & D \\ 0 & D\end{matrix} ) = ( \begin{matrix}0 & 0 & 0 \\ D & D & 0 \\ 0 & D & 0\end{matrix} )$ |
| | t = 3T | Total |
| | $( \begin{matrix}0 & 0 \\ 0 & D\end{matrix} ) \times ( \begin{matrix}D & D \\ D & 0\end{matrix} ) = ( \begin{matrix}0 & 0 & 0 \\ 0 & D & D \\ 0 & D & 0\end{matrix} )$ | $( \begin{matrix}0 & DD & 0 \\ DD & DDDD & DD \\ 0 & DD & 0\end{matrix} )$ |

In the case of [Table 5], a dual polarization is used for transmission and a dual polarization is used for reception. For example, [Table 5] shows an example of operation of a polarization mode D/D. Since the dual polarization D includes a horizontal polarization H and a vertical polarization V, the polarization mode D/D may be understood to include four polarization modes H/H, H/V, V/H, and V/V.

If a single polarized antenna is used for both transmission and reception, one polarization mode (e.g., R/R) may be used during four time slots. If a dual polarized antenna is used for both transmission and reception, four polarization modes (e.g., D/D, for example, H/H, H/V, V/H, or V/V) may be used during four time slots. However, minimum virtual elements required to form a virtual array are

$$( \begin{matrix}0 & R & 0 \\ R & R & R \\ 0 & R & 0\end{matrix} ) or ( \begin{matrix}0 & D & 0 \\ D & D & D \\ 0 & D & 0\end{matrix} ) .$$

For example, a minimum number of virtual elements required to form a virtual array is five. Therefore, in the case of [Table 4] or [Table 5], it can be interpreted that seven virtual antenna elements are wasted.

Therefore, according to an embodiment of the present disclosure, a single polarized antenna (e.g., a right-hand circularly polarized antenna) may be used for transmission, and a reconfigurable antenna may be used for reception. In this case, if a polarization of the receiving antenna is switched to use a dual polarization rather than right-hand circular polarization at t=T and t=2T, under a condition of four time slots, a polarization mode may change from a one-polarized mode R/R mode to a three-polarized mode R/RD mode. Accordingly, three signal sets separated into a horizontal polarization, a vertical polarization, and a right-hand circular polarization may be obtained, and an efficiency may be improved to 150%. A matrix product of a transmitting antenna and a receiving antenna according to the R/RD mode is represented as in [Table 6] below. [Table 6] below exemplifies virtual array formation of a three-polarized mode R/RD mode.

TABLE 6

| t = 0 | t = T | t = 2T | t = 3T | Total |
|---|---|---|---|---|
| $( \begin{matrix}R & 0 \\ 0 & 0\end{matrix} ) \times ( \begin{matrix}0 & R \\ R & R\end{matrix} ) = ( \begin{matrix}0 & R & 0 \\ R & R & 0 \\ 0 & 0 & 0\end{matrix} )$ | $( \begin{matrix}0 & R \\ 0 & 0\end{matrix} ) \times ( \begin{matrix}D & 0 \\ D & D\end{matrix} ) = ( \begin{matrix}0 & D & 0 \\ 0 & D & D \\ 0 & 0 & 0\end{matrix} )$ | $( \begin{matrix}0 & 0 \\ R & 0\end{matrix} ) \times ( \begin{matrix}D & D \\ 0 & D\end{matrix} ) = ( \begin{matrix}0 & 0 & 0 \\ D & D & 0 \\ 0 & D & 0\end{matrix} )$ | $( \begin{matrix}0 & 0 \\ 0 & R\end{matrix} ) \times ( \begin{matrix}R & R \\ R & 0\end{matrix} ) = ( \begin{matrix}0 & 0 & 0 \\ 0 & R & R \\ 0 & R & 0\end{matrix} )$ | $( \begin{matrix}0 & RD & 0 \\ RD & RRDD & RD \\ 0 & RD & 0\end{matrix} )$ |

Similarly, according to an embodiment of the present disclosure, a dual polarized antenna may be used for transmission, and a reconfigurable antenna may be used for reception. In this case, if a polarization of the receiving antenna is switched to use a right-hand circular polarization rather than a dual polarization at t=T and t=2T, during four time slots, a polarization mode may change from a four-polarized mode D/D mode to a six-polarized mode D/DR mode. In addition, during six time slots, a polarization mode may change from a four-polarized mode D/D mode to an eight-polarized mode D/DRL mode or D/DC mode. Accordingly, an efficiency may be improved to 100%. A matrix product of a transmitting antenna and a receiving antenna according to the D/DR mode and the D/DC mode is represented as in [Table 7] and [Table 8] below. [Table 7] below exemplifies virtual array formation of a six-polarized mode D/DR mode, and [Table 8] below exemplifies virtual array formation of an eight-polarized mode D/DRL mode.

TABLE 7

| t = 0 | t = T | t = 2T | t = 3T | Total |
|---|---|---|---|---|
| $( \begin{matrix}D & 0 \\ 0 & 0\end{matrix} ) \times ( \begin{matrix}0 & D \\ D & D\end{matrix} ) = ( \begin{matrix}0 & D & 0 \\ D & D & 0 \\ 0 & 0 & 0\end{matrix} )$ | $( \begin{matrix}0 & D \\ 0 & 0\end{matrix} ) \times ( \begin{matrix}R & 0 \\ R & R\end{matrix} ) = ( \begin{matrix}0 & R & 0 \\ 0 & R & R \\ 0 & 0 & 0\end{matrix} )$ | $( \begin{matrix}0 & 0 \\ D & 0\end{matrix} ) \times ( \begin{matrix}R & R \\ 0 & R\end{matrix} ) = ( \begin{matrix}0 & 0 & 0 \\ R & R & 0 \\ 0 & R & 0\end{matrix} )$ | $( \begin{matrix}0 & 0 \\ 0 & D\end{matrix} ) \times ( \begin{matrix}D & D \\ D & 0\end{matrix} ) = ( \begin{matrix}0 & 0 & 0 \\ 0 & D & D \\ 0 & D & 0\end{matrix} )$ | $( \begin{matrix}0 & RD & 0 \\ RD & RRDD & RD \\ 0 & RD & 0\end{matrix} )$ |

TABLE 8

| t = 0 | t = T | t = 2T | t = 3T |
|---|---|---|---|
| $( \begin{matrix}D & 0 \\ 0 & 0\end{matrix} ) \times ( \begin{matrix}0 & D \\ D & D\end{matrix} ) = ( \begin{matrix}0 & D & 0 \\ D & D & 0 \\ 0 & 0 & 0\end{matrix} )$ | $( \begin{matrix}0 & D \\ 0 & 0\end{matrix} ) \times ( \begin{matrix}R & 0 \\ R & R\end{matrix} ) = ( \begin{matrix}0 & R & 0 \\ 0 & R & R \\ 0 & 0 & 0\end{matrix} )$ | $( \begin{matrix}0 & 0 \\ D & 0\end{matrix} ) \times ( \begin{matrix}R & R \\ 0 & R\end{matrix} ) = ( \begin{matrix}0 & 0 & 0 \\ R & R & 0 \\ 0 & R & 0\end{matrix} )$ | $( \begin{matrix}0 & 0 \\ 0 & D\end{matrix} ) \times ( \begin{matrix}D & D \\ D & 0\end{matrix} ) = ( \begin{matrix}0 & 0 & 0 \\ 0 & D & D \\ 0 & D & 0\end{matrix} )$ |
| | t = 4T | t = 5T | Total |
| | $( \begin{matrix}0 & D \\ 0 & 0\end{matrix} ) \times ( \begin{matrix}L & 0 \\ L & L\end{matrix} ) = ( \begin{matrix}0 & L & 0 \\ 0 & L & L \\ 0 & 0 & 0\end{matrix} )$ | $( \begin{matrix}0 & 0 \\ D & 0\end{matrix} ) \times ( \begin{matrix}L & L \\ 0 & L\end{matrix} ) = ( \begin{matrix}0 & 0 & 0 \\ L & L & 0 \\ 0 & L & 0\end{matrix} )$ | $( \begin{matrix}0 & RD & 0 \\ RD & RRDD & RD \\ 0 & RD & 0\end{matrix} )$ |

When polarization characteristics of a transmitting antenna and polarization characteristics of a receiving antenna are controlled as in the embodiments described above, essential virtual elements are

$$( \begin{matrix}0 & RD & 0 \\ RD & RD & RD \\ 0 & RD & 0\end{matrix} )$$

under a condition of four time slots and

$$( \begin{matrix}0 & RLD & 0 \\ RLD & RLD & RLD \\ 0 & RLD & 0\end{matrix} )$$

under a condition of six time slots. Therefore, referring to [Table 6] to [Table 8], a number of virtual elements to be wasted is two under a condition of four time slots and three under a condition of six time slots.

In the embodiments described above, a reconfigurable virtual array is applied to a receiving antenna. However, according to another embodiment, a reconfigurable virtual array may also be applied to a transmitting antenna. In this case, under a condition of twenty-four time slots, up to sixteen polarization modes may be used, and accordingly the efficiency will be improved to 400%.

Although a structure sharing a transmitting antenna and a receiving antenna has advantages in a size of hardware and in channel estimation of communication, which are problems of a MIMO structure using separated transmitter and receiver, it still has an ambiguity problem due to received signal distortion. When the technology according to various embodiments is used, as confirmed in results of virtual array formation exemplified in [Table 6] to [Table 8], more information, for example, more polarization modes are utilized, and thus the ambiguity is reduced accordingly. Consequently, it can be said that the proposed technology is suitable for an operation method of radar-communication.

As in the various embodiments described above, by controlling operating states (e.g., a transmission mode or a reception mode) and polarization states (e.g., a horizontal polarization, a vertical polarization, a dual polarization, a left-hand circular polarization, or a right-hand circular polarization) of antenna subarrays according to a predetermined pattern, an antenna operation using a virtual array may be performed. Here, a pattern of operating states is information specifying whether each antenna subarray among the antenna subarrays is used for transmission or for reception in each time interval. For example, a pattern of operating states may be defined as indicating an index of at least one subarray used for transmission in each time interval among the plurality of antenna subarrays. In addition, a pattern of polarization states means a combination of at least one polarization (e.g., a polarization mode) used for transmission and reception and an application order of at least one polarization per time interval.

Patterns for operating states and polarization states specify, for each antenna subarray, operating states and polarization states during a plurality of time intervals allocated for a radar operation, and may be defined in various forms such as a table, a vector, and a matrix. Hereinafter in the present disclosure, a pattern for operating states and polarization states may be referred to as a “pattern for a radar operation,” an “antenna control pattern,” a “state control pattern,” a “state pattern,” or other terms having an equivalent technical meaning. Although [Table 4], [Table 5], [Table 6], [Table 7], and [Table 8] have been presented as examples of patterns for a radar operation above, a pattern for a radar operation may be defined in various ways depending on a design purpose and an application method in addition to the examples described above.

To define a pattern for a radar operation, a plurality of antenna subarrays may be divided into a plurality of groups. From a viewpoint of operation, a pattern for a radar operation may be defined to operate each group sequentially in a transmission mode. In this case, if necessary, a specific group may operate in the transmission mode during two or more transmission intervals. At least one antenna subarray belonging to at least one remaining group (hereinafter, a “reception group”) other than a group operating in the transmission mode (hereinafter, a “transmission group”) operates in a reception mode. Accordingly, in each time interval, a signal transmitted through at least one antenna subarray belonging to the transmission group may be received through at least one antenna subarray belonging to the at least one remaining group after being reflected by an object.

In addition, from a viewpoint of a polarization mode, a pattern for a radar operation may be defined as a series of polarization states applied to the transmission group and the reception group. Alternatively, a pattern for a radar operation may be defined as a series of polarization states applied to the transmission group. Alternatively, a pattern for a radar operation may be defined as a series of polarization states applied to the reception group. In this case, the pattern may be defined to include two or more polarization states. When two or more polarization states are defined to be applied to the reception group, the reception group may be used to receive signals having different polarization characteristics during a plurality of reception intervals.

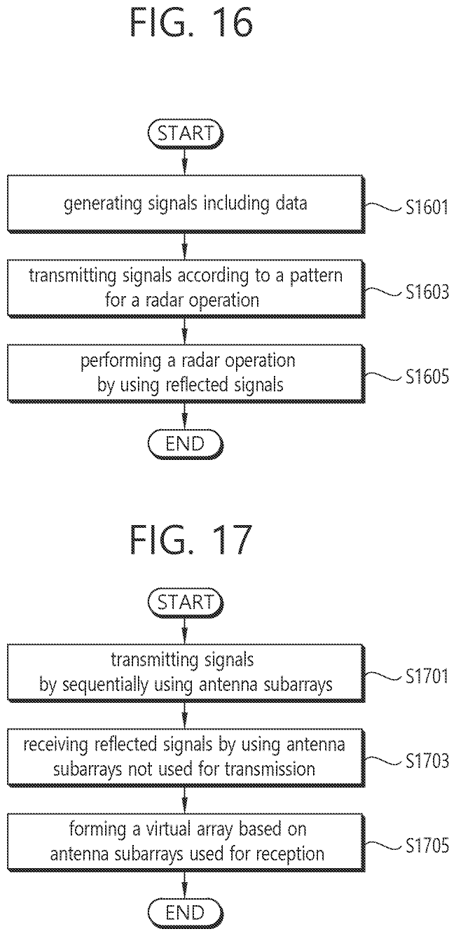

FIG. 16 shows an example of a procedure of performing communication and a radar operation, based on an embodiment of the present disclosure. FIG. 16 exemplifies an operation method of a device (e.g., a base station or a UE).

Referring to FIG. 16, in step S1601, the device generates signals including data. The device generates signals including data for communication with a counterpart device (e.g., a UE, a base station, etc.). For example, the device may generate at least one codeword by encoding information bits, perform scrambling on bits in the at least one codeword, and generate modulation symbols by modulating the scrambled bits. For example, the device may generate signals by performing at least one of encoding, scrambling, and modulation. In this case, the device may generate a signal according to a coding rate and a modulation scheme allocated by a base station. For example, before generating the signal, the device may perform scheduling or may receive scheduling information (e.g., a control signal).

In step S1603, the device transmits signals according to a pattern for a radar operation. Here, the pattern for the radar operation is defined as a combination of a transmit/receive mode per antenna subarray and a polarization mode. For example, the pattern for the radar operation specifies which operation (e.g., transmission or reception) each antenna subarray is used for according to which polarization mode during a plurality of time occasions. Therefore, the device may check the pattern for the radar operation and may transmit and receive signals while controlling the antenna according to the checked pattern.

In step S1605, the device performs a radar operation by using reflected signals. For example, the device receives reflected signals generated by the signals transmitted in step S1603 being reflected by an object, and may determine information related to a position and movement of the object by using the received signals. To this end, the device forms a virtual receive array by using signals received during a plurality of time intervals, and may perform a radar operation based on the virtual receive array. For example, the device forms a virtual receive array and maps the received signals to virtual receive signal matrices according to the virtual receive array.

According to the embodiment described with reference to FIG. 16, communication and a radar operation may be performed by using the same signals. Here, through the radar operation, at least one of a distance to a target object, a relative angle with respect to the target object, and a moving speed of the target object may be detected. The device may detect information related to the target object by applying various radar signal-processing methods in the formed virtual receive array. Specifically, the device may determine at least one of the distance to the target object, the relative angle with respect to the target object, and the moving speed of the target object based on one of intensity of the reflected signal, an angle of arrival of the reflected signal, and a channel value experienced by the reflected signal.

FIG. 17 shows an example of a procedure of forming a virtual array, based on an embodiment of the present disclosure. FIG. 17 exemplifies an operation method of an device (e.g., a base station or a UE). FIG. 17 exemplifies a case where a transmission group includes one subarray.

Referring to FIG. 17, in step S1701, the device transmits signals by sequentially using antenna subarrays. The device includes a plurality of antenna subarrays, and each subarray is connected to a transmitter and a receiver. Therefore, each subarray may operate in a transmission mode or a reception mode. Therefore, during a plurality of time intervals, the device transmits signals through at least one subarray, and in this case, a subarray operating in the transmission mode may vary according to a time interval. For example, during the plurality of time intervals, each subarray disposed at a corner of a two-dimensional antenna array may operate at least once in the transmission mode. For example, subarrays operating in the transmission mode may include four subarrays selected to maximize distances between them in a two-dimensional antenna array.

In step S1703, the device receives reflected signals by using antenna subarrays not used for transmission. While some of the subarrays operate in the transmission mode, at least one remaining subarray operates in the reception mode. In this case, the device may control a polarization state of at least one remaining subarray according to a pattern for a radar operation. Accordingly, signals transmitted through a designated polarization state and a subarray operating in the transmission mode are reflected by an object and then may be received through at least one remaining subarray operating in the designated polarization state and the reception mode. For example, steps S1701 and S1703 are performed during a same time interval.

In step S1705, the device forms a virtual array based on antenna subarrays used for reception. By forming the virtual array, signals received during the plurality of time intervals may be treated as signals received in a same time interval. Accordingly, the device may obtain an effect of using an antenna array larger than a size of actual antenna subarrays. Specifically, the device maps signals received at at least one subarray operating in the reception mode during a same time interval to a virtual receive signal matrix based on a relative position of a subarray that operated in the transmission mode. In this case, the virtual receive signal matrix has a size larger than an actual receive signal matrix. After mapping signals received in each time interval to the virtual receive signal matrix, the device sums the virtual receive signal matrices. Accordingly, a virtual array having a size larger than the actual antenna subarrays may be formed. For example, the device may form a virtual receive array as exemplified in [Table 2], [Table 4], [Table 5], [Table 6], [Table 7], or [Table 8]. Alternatively, methods other than those exemplified in [Table 2], [Table 4], [Table 5], [Table 6], [Table 7], and [Table 8] may be used.

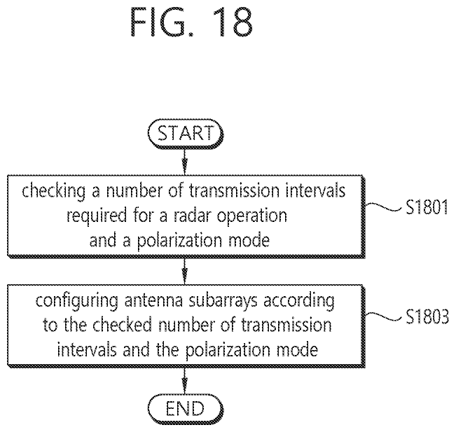

FIG. 18 shows an example of a procedure of configuring antenna subarrays for a radar operation, based on an embodiment of the present disclosure. FIG. 18 exemplifies an operation method of a device (e.g., a base station or a UE).

Referring to FIG. 18, in step S1801, the device checks a number of transmission intervals required for a radar operation and a polarization mode. A virtual array is formed for the radar operation, and a number of signal transmission/receptions required to form the virtual array may be predefined. A number of transmission intervals as many as the number of signal transmission/receptions is required, and the required number of signal transmission/receptions may vary depending on a number of signal sets to be obtained through separation by polarization. In addition, the device checks a number of transmission intervals and a polarization mode and checks a pattern (e.g., an operating-state pattern and a polarization-state pattern) to operate the checked number of transmission intervals according to the checked polarization mode. For example, in a case as in [Table 6], the device checks that four time intervals and an R/RD mode are required and checks to apply, as a polarization-state pattern, {R, R, R, R} for transmission and {R, D, D, R} for reception.

In step S1803, the device configures antenna subarrays according to the checked number of transmission intervals and the polarization mode. For example, during the transmission intervals checked in step S1801, the device controls antenna subarrays to operate in at least one polarization included in the polarization mode. Specifically, during the plurality of transmission intervals, the device may perform a transmission operation and a reception operation while sequentially applying polarization states included in the polarization mode according to a pattern corresponding to the polarization mode. In this case, according to an embodiment, a polarization state used for reception may be switched. For example, a polarization state used for reception may be configured differently according to a transmission interval. According to another embodiment, a polarization state used for transmission may be configured differently according to a transmission interval.

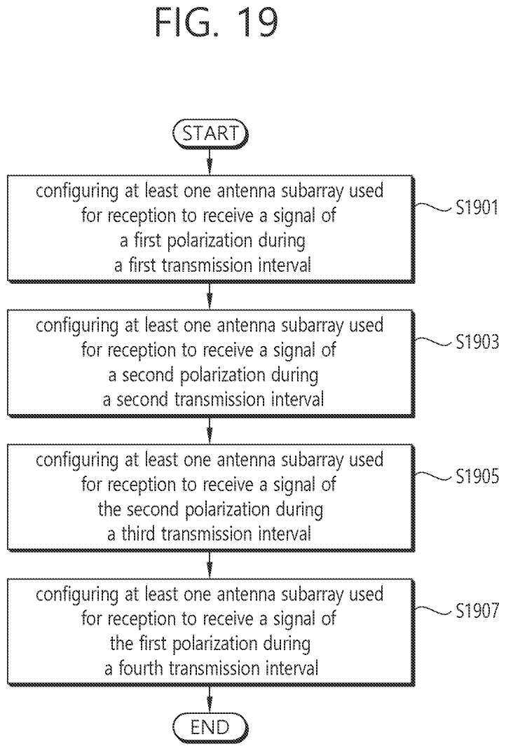

FIG. 19 shows an example of a procedure of configuring antenna subarrays for a radar operation by using a plurality of polarizations during four time intervals, based on an embodiment of the present disclosure. FIG. 19 exemplifies an operation method of a device (e.g., a base station or a UE). FIG. 19 exemplifies control operations in a case where two polarization modes are used for a reception operation during four transmission intervals.

Referring to FIG. 19, in step S1901, the device configures at least one antenna subarray used for reception to receive a signal of a first polarization during a first transmission interval. For example, the device may control at least one antenna subarray to operate in a dual-polarized mode. In this case, antenna subarrays other than at least one antenna subarray belonging to a first group used for reception may be controlled to transmit signals according to a designated polarization mode.

In step S1903, the device configures at least one antenna subarray used for reception to receive a signal of a second polarization during a second transmission interval. For example, the device may control at least one antenna subarray to operate in a circular-polarized mode. In this case, antenna subarrays other than at least one antenna subarray belonging to a second group used for reception may be controlled to transmit signals according to a designated polarization mode.

In step S1905, the device configures at least one antenna subarray used for reception to receive a signal of the second polarization during a third transmission interval. For example, the device may control at least one antenna subarray to operate in the circular-polarized mode. In this case, antenna subarrays other than at least one antenna subarray belonging to a third group used for reception may be controlled to transmit signals according to a designated polarization mode.

In step S1907, the device configures at least one antenna subarray used for reception to receive a signal of the first polarization during a fourth transmission interval. For example, the device may control at least one antenna subarray to operate in the dual-polarized mode. In this case, antenna subarrays other than at least one antenna subarray belonging to a fourth group used for reception may be controlled to transmit signals according to a designated polarization mode.

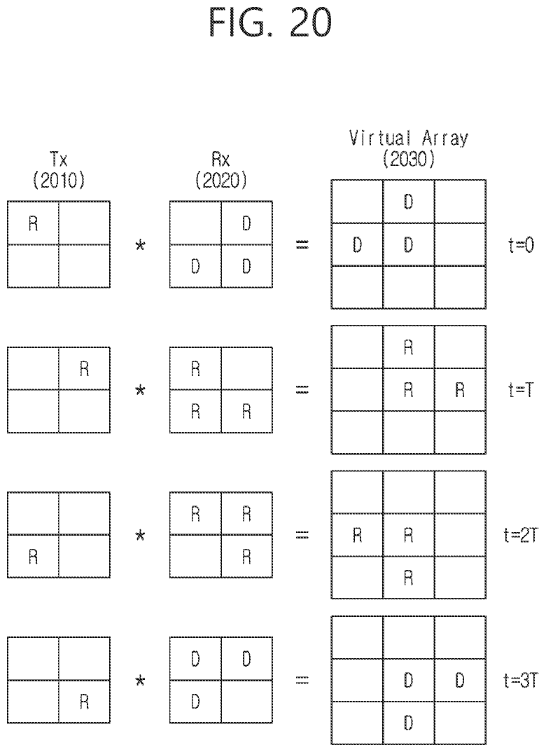

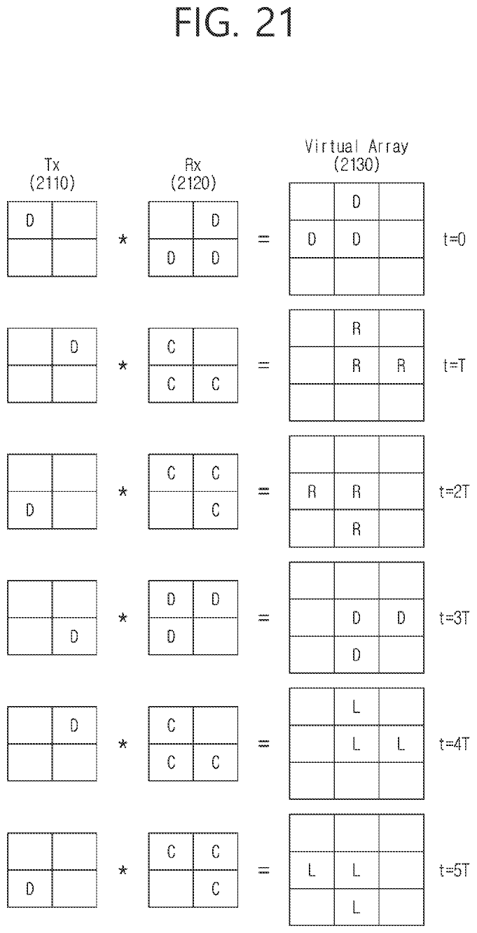

Hereinafter, with reference to FIGS. 20 and 21, the present disclosure describes more specific control of antenna subarrays and results of a virtual array. FIG. 20 exemplifies a case where right-hand circular polarization is used for a transmission operation and a dual polarization and right-hand circular polarization are used for a reception operation, and FIG. 21 exemplifies a case where a dual polarization is used for a transmission operation and a dual polarization and a circular polarization are used for a reception operation.

FIG. 20 shows an example of antenna-subarray control for a radar operation and a result of a virtual array, based on an embodiment of the present disclosure. Referring to FIG. 20, in a transmission operation (2010), signals of right-hand circular polarization are transmitted by sequentially using four subarrays. Simultaneously, in a reception operation (2020), signals of a dual polarization or right-hand circular polarization are received by using the remaining three subarrays. Specifically, the reception operation (2020) uses a dual polarization during a first transmission interval and a fourth transmission interval and uses right-hand circular polarization during a second transmission interval and a third transmission interval. Accordingly, two signal sets having dual polarization characteristics during the first and fourth transmission intervals and another one signal set having a right-hand circular polarization mode characteristic during the second and fourth transmission intervals may be obtained.

FIG. 21 shows another example of antenna-subarray control for a radar operation and a result of a virtual array, based on an embodiment of the present disclosure. Referring to FIG. 21, in a transmission operation (2110), signals of a dual polarization are transmitted by sequentially using six subarrays. Simultaneously, in a reception operation (2120), signals of a dual polarization, right-hand circular polarization, and left-hand circular polarization are received by using the remaining three subarrays. Specifically, the reception operation (2120) uses a dual polarization during a first transmission interval and a fourth transmission interval, uses right-hand circular polarization during a second transmission interval and a third transmission interval, and uses left-hand circular polarization during a fifth transmission interval and a sixth transmission interval. Accordingly, two signal sets having dual polarization characteristics during the first and fourth transmission intervals, another one signal set having right-hand circular polarization characteristics during the second and fourth transmission intervals, and still another one signal set having left-hand circular polarization characteristics during the fifth and sixth transmission intervals may be obtained.

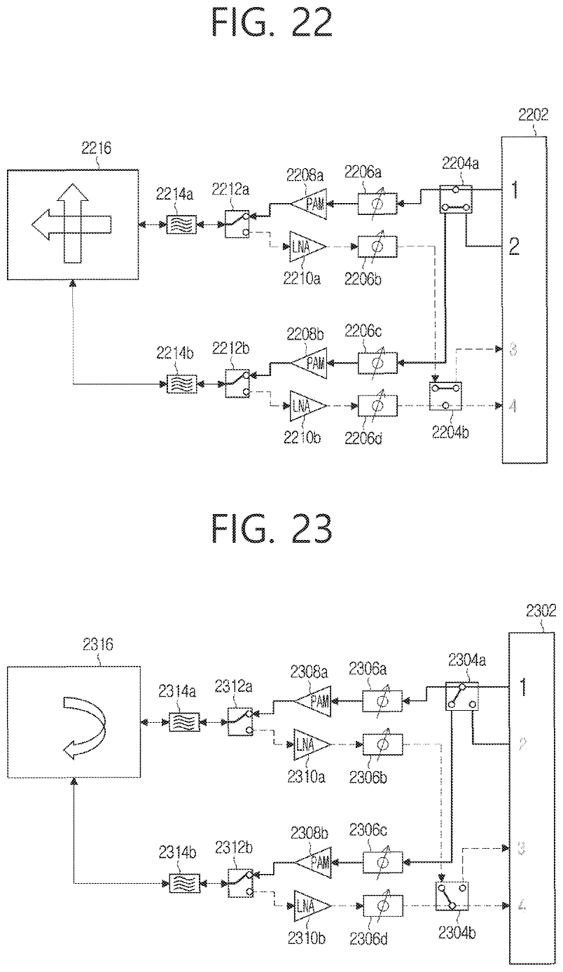

As described above, various polarization modes may be used for an antenna operation. In this case, a circuit of a transmitter or a receiver may be controlled to support various polarization modes. Control states of the circuit according to each polarization mode are as in FIGS. 22 to 25 below.

FIG. 22 shows an example of a circuit control state that performs a transmission operation in a dual-polarized mode, based on an embodiment of the present disclosure. Referring to FIG. 22, the circuit includes a modem (2202), a first path switch (2204a), a second path switch (2204b), a first phase shifter (2206a), a second phase shifter (2206b), a third phase shifter (2206c), a fourth phase shifter (2206d), a first power amplifier (PAM) (2208a), a second power amplifier (2208b), a first low noise amplifier (LNA) (2410a), a second low noise amplifier (2410b), a first duplexer (2212a), a second duplexer (2212b), a first filter (2214a), a second filter (2214b), and an antenna (2216). The modem (2202) includes two signal output ports (e.g., port #1 and port #2) and two signal input ports (e.g., port #3 and port #4). When transmitting a signal in the dual-polarized mode, the modem (2202) outputs a first signal through port #1 and outputs a second signal through port #2. The first signal is delivered to the antenna (2216) through the first path switch (2204a), the first phase shifter (2206a), the first power amplifier (2208a), the first duplexer (2212a), and the first filter (2214a). Similarly, the second signal is delivered to the antenna (2216) through the first path switch (2204a), the third phase shifter (2206c), the second power amplifier (2208b), the second duplexer (2212b), and the second filter (2214b). The first signal and the second signal are brought into the same phase or a 180-degree difference by the first phase shifter (2206a) and the third phase shifter (2206c), are input to different ports of the antenna (2216), and then may be transmitted with different polarizations (e.g., a vertical polarization and a horizontal polarization).

FIG. 23 shows an example of a circuit control state that performs a transmission operation in a circular-polarized mode, based on an embodiment of the present disclosure. Referring to FIG. 23, the circuit includes a modem (2302), a first path switch (2304a), a second path switch (2304b), a first phase shifter (2306a), a second phase shifter (2306b), a third phase shifter (2306c), a fourth phase shifter (2306d), a first power amplifier (2308a), a second power amplifier (2308b), a first low noise amplifier (2410a), a second low noise amplifier (2410b), a first duplexer (2312a), a second duplexer (2312b), a first filter (2314a), a second filter (2314b), and an antenna (2316). The modem (2302) includes two signal output ports (e.g., port #1 and port #2) and two signal input ports (e.g., port #3 and port #4). When transmitting a signal in the circular-polarized mode, the modem (2302) outputs a signal through port #1. The signal is branched into a first signal and a second signal by the first path switch (2304a). Thereafter, the first signal is delivered to a circularly polarized antenna (2316) through the first phase shifter (2306a), the first power amplifier (2308a), the first duplexer (2312a), and the first filter (2314a). In addition, the second signal is delivered to the antenna (2316) through the third phase shifter (2306c), the second power amplifier (2308b), the second duplexer (2312b), and the second filter (2314b). The first signal and the second signal have a phase difference of 90 degrees or −90 degrees by the first phase shifter (2306a) and the third phase shifter (2306c) and are input to different ports of the antenna (2316). One of the different ports is connected to antenna elements for transmitting a vertical polarization, and the other is connected to antenna elements for transmitting a horizontal polarization. A signal of a circular polarization is generated by combining the same first signal and second signal having a phase difference of 90 degrees or −90 degrees into a horizontal polarization and a vertical polarization. Accordingly, a signal output from port #1 may be transmitted in a circular polarization (e.g., a right-hand circular polarization and a left-hand circular polarization).

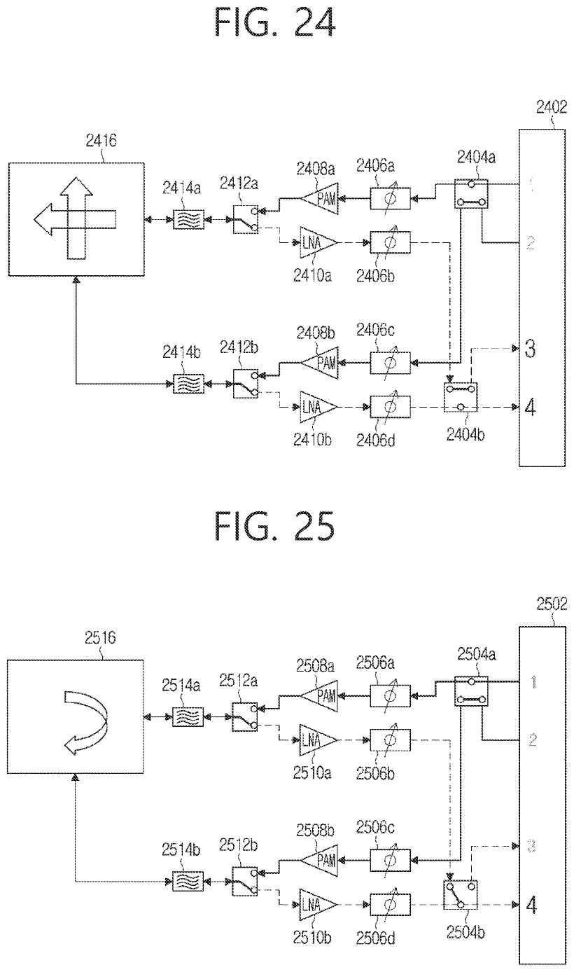

FIG. 24 shows an example of a circuit control state that performs a reception operation in a dual-polarized mode, based on an embodiment of the present disclosure. Referring to FIG. 24, the circuit includes a modem (2402), a first path switch (2404a), a second path switch (2404b), a first phase shifter (2406a), a second phase shifter (2406b), a third phase shifter (2406c), a fourth phase shifter (2406d), a first power amplifier (2408a), a second power amplifier (2408b), a first low noise amplifier (2410a), a second low noise amplifier (2410b), a first duplexer (2412a), a second duplexer (2412b), a first filter (2414a), a second filter (2414b), and an antenna (2416). When receiving a signal in the dual-polarized mode, a first signal detected based on the vertical polarization and a second signal detected based on the horizontal polarization by the antenna (2416) are output to different ports. The first signal is input to port #3 of the modem (2402) through the first filter (2414a), the first duplexer (2412a), the first low noise amplifier (2410a), the second phase shifter (2406b), and the second path switch (2404b). In addition, the second signal is input to port #4 of the modem (2402) through the second filter (2414b), the second duplexer (2412b), the second low noise amplifier (2410b), the fourth phase shifter (2406d), and the second path switch (2404b). Accordingly, the modem (2402) may obtain the first signal and the second signal.

FIG. 25 shows an example of a circuit control state that performs a reception operation in a circular-polarized mode, based on an embodiment of the present disclosure. Referring to FIG. 25, the circuit includes a modem (2502), a first path switch (2504a), a second path switch (2504b), a first phase shifter (2506a), a second phase shifter (2506b), a third phase shifter (2506c), a fourth phase shifter (2506d), a first power amplifier (2508a), a second power amplifier (2508b), a first low noise amplifier (2510a), a second low noise amplifier (2510b), a first duplexer (2512a), a second duplexer (2512b), a first filter (2514a), a second filter (2514b), and an antenna (2516). The modem (2502) includes two signal output ports (e.g., port #1 and port #2) and two signal input ports (e.g., port #3 and port #4). When receiving a signal in the circular-polarized mode, a first signal detected based on the vertical polarization and a second signal detected based on the horizontal polarization by the antenna (2516) are output to different ports. The first signal is input to port #4 of the modem (2502) through the first filter (2514a), the first duplexer (2512a), the first low noise amplifier (2510a), the second phase shifter (2506b), and the second path switch (2504b). In addition, the second signal is input to port #4 of the modem (2502) through the second filter (2514b), the second duplexer (2512b), the second low noise amplifier (2510b), the fourth phase shifter (2506d), and the second path switch (2504b). The first signal and the second signal are phase-shifted by the second phase shifter (2506b) and the fourth phase shifter (2506d) in different paths to remove a 90-degree or −90-degree phase difference generated in a transmission process, and accordingly signals may be combined in the same phase. Accordingly, the modem (2402) may obtain a signal received in the circular polarization.

The structure described with reference to FIG. 25 is one example of a circuit structure and control for generating various polarizations. Therefore, another circuit structure may be used to generate various polarizations. For example, various polarizations may be generated by using control of an antenna pattern. Specifically, as a diode is included in an antenna pattern, various polarizations may be generated by changing an operating mode of the antenna based on an operating state of the diode. As another example, various polarizations may be generated by using a reconfigurable feeding network. Specifically, if a signal output from a port is supplied to an antenna element for a linear polarization according to control of the feeding network, a linear polarization is generated, and if a signal output from a port is distributed to antenna elements for linear polarizations in different directions according to control of the feeding network, a circular polarization may be generated.

According to the various embodiments described above, the present disclosure makes it possible to obtain a more improved angular resolution by utilizing a structure in which a transmitter and a receiver used in existing communication share an antenna by using a switch. This will facilitate implementation of a radar-communication convergence system utilizing an existing TDD-based communication system. For example, the proposed technology enables simultaneous operation of high-performance sensing and communication in a future 6G and wireless-network environment. Furthermore, the proposed technology may be extended to various application fields such as communication using sensing and sensing using communication.

According to various embodiments, a hybrid beamforming scheme forming one beam by all subarrays operating simultaneously in a transmission mode or a reception mode may also be supported. For example, a device according to various embodiments of the present disclosure may support both a hybrid scheme and a MIMO radar scheme. However, a more improved resolution may be obtained when operating as MIMO than when all subarrays operate simultaneously in the transmission mode or the reception mode. Additionally, to obtain higher angular resolution, a spacing of subarrays may be spaced wider than an aperture of one subarray.

The present disclosure relates to a transmitter and receiver system of a form in which a transmitter and a receiver used in existing communication share an antenna through a switch. In addition, the present disclosure relates to a MIMO radar technology that obtains not only improved angular resolution but also improved radar performance by having more polarization modes by utilizing a switch and a phase shifter. This provides an advantage that a radar-communication convergence system utilizing an existing TDD-based communication system can be implemented. Furthermore, this will enable simultaneous operation of high-performance sensing and communication in a future 6G and wireless-network environment. Furthermore, the proposed technology may be extended to various application fields such as communication using sensing and sensing using communication.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL AVAILABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
generating, by a first device, by encoding information bits, at least one codeword;
generating, by the first device, based on the at least one codeword, modulation symbols;
transmitting, by the first device, signals including the modulation symbols; and
when the signals are reflected by an object and received, performing a radar operation by using the reflected signals,
wherein the radar operation is performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

2. The method of claim 1,
wherein the signals are transmitted, in each of the plurality of time intervals, through at least one subarray operating in a transmission mode among the plurality of subarrays, and are received through at least one remaining subarray operating in a reception mode.

3. The method of claim 2,
wherein the at least one subarray operating in the transmission mode varies according to the time interval.

4. The method of claim 3,
wherein the at least one subarray operating in the transmission mode includes one subarray in each of the time intervals.

5. The method of claim 4,
wherein the at least one subarray operating in the transmission mode is one of subarrays located at corners of a two-dimensional antenna array.

6. The method of claim 2,
wherein the at least one remaining subarray operating in the reception mode is controlled to receive a signal of a first polarization characteristic in a first time interval among the time intervals and to receive a signal of a second polarization characteristic in a second time interval among the time intervals.

7. The method of claim 2,
wherein the time intervals include four time intervals, and
wherein the at least one remaining subarray operating in the reception mode is controlled to receive a signal of vertical polarization and a signal of horizontal polarization in a first time interval and a fourth time interval, and to receive a signal of circular polarization in a second time interval and a third time interval.

8. The method of claim 2,
wherein the time intervals include six time intervals,
wherein the at least one remaining subarray operating in the reception mode is controlled to receive a signal of vertical polarization and a signal of horizontal polarization in a first time interval and a fourth time interval, to receive a signal of a first circular polarization in a second time interval and a third time interval, and to receive a signal of a second circular polarization in a fifth time interval and a sixth time interval,
wherein one of the first circular polarization and the second circular polarization includes right-hand circular polarization, and
wherein another one of the first circular polarization and the second circular polarization includes left-hand circular polarization.

9. The method of claim 1,
wherein an interval between the subarrays is spaced wider than an aperture of one subarray.

10. The method of claim 1,
wherein the virtual array is determined based on a convolution of a first array representing a position of at least one subarray operating in the transmission mode in a same time interval and a second array representing a position of at least one subarray operating in the reception mode.

11. The method of claim 1,
wherein each of the subarrays includes at least one antenna element.

12. The method of claim 1,
wherein the virtual array is formed to have a size larger than the antenna array.

13. A communication device, comprising:
at least one processor;
at least one computer memory connected to the at least one processor and storing instructions that, based on being executed by the at least one processor, cause the communication device to perform operations,
wherein the operations comprising:
generating, by encoding information bits, at least one codeword;
generating, based on the at least one codeword, modulation symbols;
transmitting signals including the modulation symbols; and
when the signals are reflected by an object and received, performing a radar operation by using the reflected signals,
wherein the radar operation is performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.

14. The method of claim 13, further comprising:
a transceiver connected to the at least one processor and including a plurality of transmitters and a plurality of receivers,
wherein the at least one processor controls the transceiver to transmit and receive the signals.

15. A non-transitory computer-readable medium storing at least one instruction, comprising the at least one instruction being executable by a processor,
wherein the at least one instruction is configured to perform operations comprising:
generating, by encoding information bits, at least one codeword;
generating, based on the at least one codeword, modulation symbols;
transmitting signals including the modulation symbols; and
when the signals are reflected by an object and received, performing a radar operation by using the reflected signals,
wherein the radar operation is performed, during a plurality of time intervals, based on a virtual array formed by using signals transmitted through at least one subarray operating in at least one polarization state among a plurality of subarrays included in an antenna array and received through at least one remaining subarray operating in a plurality of polarization states.
